(19) United States
(12) Patent Application Publication
(10) Pub. No.: US 2022/0268375 A1
(43) Pub. Date: Aug. 25, 2022

(54) MULTI-LAYER COATED STEEL PIPE COMPRISING AN ADNESIVE OR EPOXY LAYER

(71) Applicant: SHAWCOR LTD., Toronto (CA)

(72) Inventors: Eileen Wan, Toronto (CA); CATHERINE LAM, Toronto (CA); TOR FREDRIK BREDELI, Toronto (CA); TORGEIR SLETVOLD, Toronto (CA); GUIDO RIDOLFI, Toronto (CA)

(21) Appl. No.: 17/630,085

(22) PCT Filed: Jul. 7, 2020
(86) PCT No.: PCT/CA2020/051025

§ 371 Date: Jan. 25, 2022

Related U.S. Application Data
(60) Provisional application No. 62/878,543, filed on Jul. 25, 2019.

(51) Int. Cl. F16L 9/147; F16L 58/10; B05D 7/14

(52) U.S. Cl. CPC F16L 9/147; F16L 58/1081; B05D 7/148

(57) ABSTRACT

A multi layer pipe coating for steel pipe, and a method of production of same. The multi layer coated steel pipe has a first layer of coating, which is an anti-corrosion coating, a second layer of coating, comprising a thermoplastic selected from the group consisting of polyphenylene sulfide, polypropylene, and polystyrene, an epoxy intermediate layer between the second layer of coating and a third layer of coating, and a third layer of coating, which comprises a thermoplastic selected from the group consisting of polyphenylene sulfide, polypropylene and polystyrene. The second layer of coating and the third layer of coating comprise different thermoplastics.

### FIELD

The present disclosure is related to a method and apparatus for coating a pipe section, and particularly for manufacturing a pipe section with layers of coating.

### BACKGROUND

An oil and gas pipeline typically made from a plurality of steel pipe sections coupled end-to-end through what is often referred to as “girth weld”—a weld around the perimeter of the steel pipe sections.

Fusion bonded epoxy (FBE) is often used as an anti-corrosion coating on pipe. FBE consists of a solid epoxy which is applied to a clean, hot pipe, provided with an appropriate anchoring pattern, typically using a powder coating process. The FBE powder melts when it contacts the hot pipe, forming a generally uniform film surface. FBE coatings provide excellent anti-corrosion properties, but have poor low temperature bend-ability and impact resistance when used as a single layer coating, and are thus prone to impact damage during transportation. Single layer FBE coatings are also prone to absorbing water when exposed to elevated temperatures (above 50° C.) in hot and wet environments; this in turn can cause blistering when induction heating is used in preparing a field joint.

Pipeline coatings are often multi-layer laminates, comprising such an anti-corrosion coating, with other coatings overtop of the anti-corrosion coating, to provide impact resistance, insulation, and/or weight. For example, the FBE coating may be coated with a polyethylene or polypropylene topcoat.

In multi-layer pipeline coatings, inter layer adhesion remains a challenge. Often, tie layers may be used between the multiple layers of the coating, to aid in bonding of the layers together. In some embodiments, the tie layer may be a blend of the two coating layers—in the case of a tie layer for an interface between an FBE coating and a polyethylene coating, for example, the tie layer may be a polyethylene/epoxy blend. In other embodiments, the tie layer may be an adhesive layer or an epoxy, as described in U.S. Pat. No. 5,178,902, assigned to the present applicant, and incorporated herein by reference, or a reactive polyolefin, such as an acetate, acrylate, or anhydride polyolefin formulation. Tie layers are quite specific to the materials of the layers for which they are used, with considerable uncertainty as to which materials will be appropriate for use as tie layers for different combinations of materials.

Other prior art approaches include “compatibilizing” the layers—for example, using a blend of the ingredients of the two layers, for example, in an interpenetrating polymer network, as described in U.S. Pat. Nos. 5,198,497, 5,709,948, 9,231,943, 7,790,288, and patent publication 2007/0034316, all incorporated herein by reference.

High performance pipeline, such as pipeline meant for high temperature transportation of oil, is also known. For example, WO 2014/131127, incorporated herein by reference, described a polymeric composition for insulating pipelines comprising a layer of solid or foam insulation comprising a high temperature resistant polysulfone, a polyphenylsulfone, or a polyethersulfone. The insulated high-temperature transport conduit (or pipe) described in that patent application comprises a continuous steel pipe made up of one or more pipe sections, a corrosion protection layer over the outer surface of the steel pipe, and a first thermal insulation layer comprising a polysulfone having a Vicat softening point greater than 200 degrees celcius and a thermal conductivity of less than about 0.40 W/mK. The polysulfone may comprises phenyl groups bridged by sulfone, ether and isopropylidene bridging groups, for example, the polysulfone may comprise a polyphenylsulfone.

Polystyrene or styrene-based thermoplastic thermal insulation coatings, and multilayer coatings comprising a polystyrene or styrene-based thermoplastic are described in U.S. Pat. No. 8,714,206, incorporated herein by reference.

Thermal insulation coatings comprising polycarbonate and polycarbonate blends, polyphenylene oxide and polyphenylene oxide blends, polyamides, polymethylpentene and polymethylpentene blends, cyclic olefin copolymers and blends thereof, and partially crosslinked thermoplastic elastomers are described in U.S. Pat. No. 8,397,765, incorporated herein by reference.

Thermal insulation coatings comprising solid or foamed polypropylene homopolymer or copolymer, polybutylene, polyethylene, polystyrene, high impact or modified polystyrene, crosslinked or partially cross-linked polypropylene and polyethylenes, are described in U.S. Pat. No. 10,161,556, incorporated herein by reference.

In certain embodiments, as described in WO 2014/131127, the coated pipe may comprise a second thermal insulation layer provided over the polysulfone layer, where the second thermal insulation layer is a thermoplastic in the form of a solid, a blown foam, or a syntactic foam, selected from polypropylene, polybutylene, polyethylene, polystyrene and copolymers, blends and elastomers thereof, where the polystyrene may comprise high impact polystyrene.

Again, in these embodiments, inter layer adhesion is a challenge. A tie layer, for example, a hydroxyl-functionalized polyethersulfone, or an olefin-based copolymer, may be used to promote bonding between the layers.

There is increasing demand for higher performance insulation materials in pipeline coatings. Polyphenylene sulfide is a high performance thermoplastic with a maximum service temperature of 218 degrees C., provides excellent chemical and thermal resistance, and can be used in pipeline coatings. Due to its cost, it is preferable to use polyphenylene sulfide in a multi-layer coating, for example, as an internal layer, or a layer proximal to the pipe, with an exterior polypropylene (solid, foam, or syntactic) coating. However, adhesion between polyphenylene sulfide and polypropylene has been a challenge.

Polystyrene coatings also provide excellent heat insulation properties. Adhesion between polypropylene and polystyrene, for example, also remains a challenge.

It would be desirable to provide a high performance pipeline meant for high temperature transportation of oil, having multiple insulation layers with superior inter-layer adhesion.

### SUMMARY OF THE INVENTION

According to one aspect of the present invention is provided a multi layer coated steel pipe, comprising: an inner steel pipe; a first layer of coating, which is an anti-corrosion coating; a second layer of coating, comprising a thermoplastic selected from the group consisting of polyphenylene sulfide, polypropylene, and polystyrene; an epoxy intermediate layer between the second layer of coating and a third layer of coating; and the third layer of coating, which comprises a thermoplastic selected from the group consisting of polyphenylene sulfide, polypropylene and polystyrene; wherein the second layer of coating and the third layer of coating comprise different thermoplastics.

According to certain embodiments, the multi layer coated steel pipe further comprises one or more additional layers of coating overtop of the third layer of coating.

According to certain embodiments, the first layer coating is an epoxy coating, preferably a fusion bonded epoxy.

According to certain embodiments, the multi layer coated steel pipe further comprises one or more tie layers, each tie layer situated between any two layers of coating.

According to certain embodiments, the multi layer coated steel pipe further comprises a first tie layer between the first layer of coating and the second layer of coating.

According to certain embodiments, the multi layer coated steel pipe further comprises a second tie layer between the second layer of coating and the intermediate layer.

According to certain embodiments, the multi layer coated steel pipe further comprises a third tie layer between the intermediate layer and the third layer of coating.

According to certain embodiments, the first layer of coating is a fusion bonded epoxy, the second layer of coating comprises polyphenylene sulfide, the third tie layer is a maleic anhydride grafted polypropylene, and the third layer of coating is a polypropylene.

According to certain embodiments, the multi layer coated steel pipe further comprises one or more additional layers overtop of the third layer of coating.

According to certain embodiments, the one or more additional layers comprise polypropylene.

According to certain embodiments, the first layer of coating is a fusion bonded epoxy, the second layer of coating is a polypropylene, the second tie layer is a maleic anhydride grafted polypropylene, the third tie layer is a maleic anhydride grafted polystyrene, and the third layer of coating is a polystyrene.

According to certain embodiments, the multi layer coated steel pipe further comprises one or more additional layers overtop of the third layer of coating.

According to certain embodiments, the one or more additional layers comprise polystyrene.

According to certain embodiments, the epoxy intermediate layer is a powder coated fusion bonded epoxy.

According to a further aspect of the present invention is provided a method of manufacturing a multi layered coated steel pipe section, comprising: step (a), displacing a steel pipe section longitudinally through a coating apparatus; step (b), applying a first layer of circumferential coating onto said steel pipe section; step (c), applying a second layer of circumferential coating, comprising a thermoplastic selected from the group consisting of polyphenylene sulfide, polypropylene, and polystyrene, onto said first layer of circumferential coating by said coating apparatus; step (d), applying an epoxy layer onto said second layer of circumferential coating; step (e), applying a third layer of circumferential coating, comprising a thermoplastic selected from the group consisting of polyphenylene sulfide, polypropylene and polystyrene, onto said epoxy layer; wherein the first layer and the third layer comprise different thermoplastics.

According to certain embodiments, the application of the epoxy layer is a fusion bonded epoxy applied as a powder coating.

According to certain embodiments, prior to the application of the epoxy layer, the second layer of circumferential coating is heated to above or near its melting point.

According to certain embodiments, the application of the first layer of circumferential coating onto said steel pipe section is by said coating apparatus.

According to certain embodiments, the first layer coating is an epoxy coating, preferably a fusion bonded epoxy and the application of said first layer is by means of a powder coating.

According to certain embodiments, the method further comprises a step (b1) between steps (b) and (c), wherein step (b1) comprises applying a first tie layer overtop of said first layer of circumferential coating, before applying the second layer of circumferential coating.

According to certain embodiments, the method further comprises a step (c1) between steps (c) and (d), wherein step (c1) comprises applying a second tie layer overtop of said second layer of circumferential coating, before applying the epoxy layer.

According to certain embodiments, the method further comprises a step (d1) between steps (d) and (e), wherein step (d1) comprises applying a third tie layer overtop of said epoxy layer, before applying the third layer of circumferential coating.

According to certain embodiments, the first layer of coating comprises a fusion bonded epoxy, the second layer of coating comprises a polyphenylene sulfide, the epoxy intermediate layer comprises a fusion bonded epoxy, the third tie layer comprises a maleic anhydride grafted polypropylene, and the third layer of coating comprises polypropylene.

According to certain embodiments, the first layer of coating comprises a fusion bonded epoxy, the first tie layer comprises a maleic anhydride grafted polypropylene, the second layer of coating comprises a polypropylene, the second tie layer comprises a maleic anhydride grafted polypropylene, the epoxy intermediate layer comprises a fusion bonded epoxy, the third tie layer comprises a maleic anhydride grafted polystyrene, and the third layer of coating comprises a polystyrene.

According to certain embodiments, step (c) occurs before the first layer of circumferential coating is fully gelled.

According to certain embodiments, step (d) occurs while the second layer of circumferential coating is still above its softening point.

According to certain embodiments, step (e) occurs before the epoxy layer is fully gelled.

According to certain embodiments, the application of the epoxy layer is performed by the coating apparatus.

According to certain embodiments, the application of the third layer of circumferential coating is performed by the coating apparatus.

According to certain embodiments, the application of one or more of the first, second, and third tie layers is performed by the coating apparatus.

According to certain embodiments, all steps are performed in-line.

According to certain embodiments, the method further comprises applying a fourth layer of circumferential coating overtop of the third layer.

According to certain embodiments, the method further comprises applying an outer jacket coating overtop of the third or fourth layer of circumferential coating.

According to certain embodiments, the fourth layer of circumferential coating is a polypropylene or a polystyrene.

### DETAILED DESCRIPTION

It has been found that a layer of epoxy, between layers of polyphenylene sulfide, polypropylene, or polystyrene, can promote inter-layer adhesion. Preferably the layer of epoxy is a fusion bonded epoxy applied as a powder coating. Preferably, the layer on which the epoxy is applied to is freshly applied and not yet fully set. Alternatively, the layer on which the epoxy is applied to may be heated to a temperature near or above its melting/softening point before applying the layer of epoxy. Preferably, the epoxy layer is not fully gelled, to maximize receptivity to adhesion, when a coating layer is added overtop of it. Advantageously, the tie layer can be applied in-line, using a liquid or powder spray apparatus, between the application of the layers of polyphenylene sulfide, polypropylene or polystyrene, allowing for efficient manufacture.

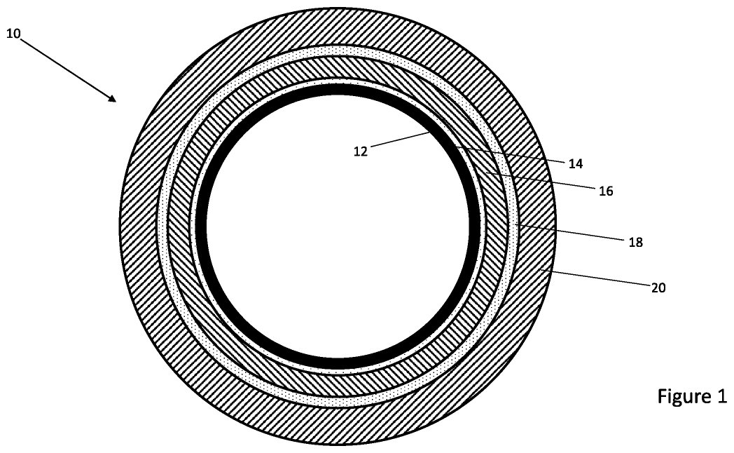

FIG. 1 shows a schematic transverse cross-section (not to scale) of one embodiment of a multi layer pipe of the present invention. It would be appreciated that the figures, including FIG. 1, are merely of schematic nature and not to scale. In particular, the thicknesses of some of the layers making up the coatings are exaggerated in relation to the thicknesses of the other layers and also relative to the thickness and diameter of the steel pipe. Multi layer pipe 10 comprises an inner steel pipe 12, which is coated, in a customary manner, with an anti-corrosion layer 14. For example, anti-corrosion layer 14 may be an epoxy, such as a fusion bonded epoxy, which is powder coated onto a clean, hot, steel pipe 12 with an appropriate anchor pattern. Anti-corrosion layer 14 may itself consist of multiple layers. Overtop of the anti-corrosion layer 14 is insulation coating layer 16, which may be, for example, polyphenylene sulfide, polystyrene, or polypropylene. Coating layer 16 may be applied overtop of anti-corrosion layer 14 via extrusion, for example, through a cross head die or a side extruder, or may be applied through any other method known in the art. Multi layer pipe 10 also comprises intermediate layer 18, which promotes adhesion between coating layers 16, 20. Intermediate layer 18 is an epoxy, for example, a fusion bonded epoxy. Intermediate layer 18 has been found to be especially effective in promoting adhesion between coating layers 16, 20 when it is applied as a powder (spray coated) onto a coating layer 16 that has not yet fully set, or which has been heated to a temperature approaching or above its melting point. However, intermediate layer 18 may also be applied as a liquid spray, or applied to the pipe utilizing any other known means. In addition, intermediate layer 18 has been found to be particularly effective in promoting adhesion when the layer applied overtop of it is applied before the intermediate layer 18 has fully gelled, for example, is still liquid, and receptive to adhesion. Coating layer 20 is a thermoplastic, for example, polystyrene, polypropylene, or polyphylenene sulfide, but is a different thermoplastic than coating layer 16. For example, coating layer 16 may be polyphenylene sulfide and coating layer 20 may be polypropylene; or coating layer 16 may be polypropylene and coating layer 20 may be polystyrene; but coating layers 16 and 20 may not both be polypropylene.

The anti-corrosion layer 14 typically has a thickness of up to 1 mm, more typically up to about 0.5 mm. Coating layers 16, 20 can have similar or very different thicknesses, and may be foamed to different densities. Typically coating layer has a thickness of from about 30 to about 70 mm, for example from about 40 to about 60 mm, or about 50 mm, such that the temperature at the outer surface of the coating layer 16 is from about 90 to about 150 degrees C. (for a pipe filled with or transporting fluid at a temperature of up to about 200 degrees C.). Coating layer 20 is typically of a thickness of from about 20 to about 70 mm, for example from about 30 to about 50 mm, or about 35 mm.

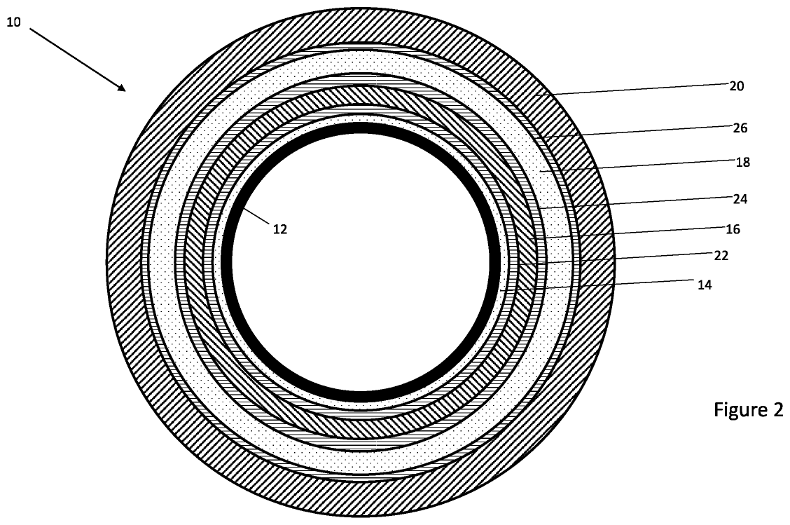

A tie layer may be used between any two layers of coating, to further promote bonding between layers. FIG. 2 shows an example of a multi layer pipe 10 similar to that of FIG. 1, but having a tie layer between each of the layers of coating. Multi layer pipe 10 comprises inner steel pipe 12, which is coated, in a customary manner, with an anti-corrosion layer 14, such as a fusion bonded epoxy. Overtop of the anti-corrosion layer 14 is a tie layer 22, which improves bonding and inter layer adhesion between anti-corrosion layer 14 and coating layer 16, which may be polyphenylene sulfide, polystyrene, or polypropylene. Multi layer pipe 10 further comprises tie layer 24, which improves bonding and inter layer adhesion between coating layer 16 and intermediate layer 18, which is an epoxy, for example a fusion bonded epoxy. A further tie layer 26 improves bonding and inter layer adhesion between intermediate layer 18 and coating layer 20, which may be polyphenylene sulfide, polystyrene, or polypropylene, but not the same thermoplastic as coating layer 16. Further (not shown), there may be a bonding layer between steel pipe 12 and anti-corrosion layer 14, as previously known in the art, for example, a primer layer, for example a phenolic primer such as a phenol-formaldehyde resin. As would be appreciated, though FIG. 2 shows tie layers 22, 24 and 26, any one or more such tie layers may be omitted.

An outer protective topcoat, also called an outer jacket (not shown) may be added over the coating layer 20, to provide further resistance to static pressure and water ingress at great depths, particularly if coating layer 20 is foamed. The outer protective topcoat may also function to provide weathering resistance, chemical resistance and mechanical protection during installation, and/or to improve the frictional characteristics of the insulation system. Outer protective topcoat may comprise the same or different polymeric materials as one or both of coating layers 16, 20, or a modified or reinforced version thereof, but is preferably in a solid, unfoamed state. For example, where coating layer 20 comprises a foamed polystyrene, outer protective topcoat may be a solid, unfoamed polystyrene. It may be advantageous to provide an adhesive layer, a tie layer, and/or an epoxy layer such as of fusion bonded epoxy between the coating layer 20 and the outer protective topcoat, especially when coating layer 20 and the outer protective topcoat are comprised of different polymeric materials. Similar methods and materials as described above for improving inter layer adhesion may be utilized between coating layer 20 and the outer protective topcoat.

Other layers may also be present, such as a concrete weight coating, applied through an impingement process or other means, as prior described in the art. For example, additional layers, such as a fourth layer of thermoplastic, may be added between the coating layer 20 and protective topcoat. This fourth layer of thermoplastic may be of the same or of a different composition as coating layer 20.

The term “polyphenylene sulfide”, when used in this application to describe a coating layer, means a polymeric compound which contains a polymer of para-phenylene units alternating with sulfide linkages, having the following formula:

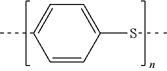

The polyphenylene sulfide may be unfilled or may comprise glass or mineral filling. Polyphenylene sulfide may be linear, branched, and/or cured, and it may be crosslinked, partially crosslinked, or non-crosslinked. It typically has a maximum continuous service temperature of 200-220 degrees C., thermal insulation of 0.21-0.32 W/m.K, and extremely low coefficient of linear thermal expansion, shrinkage, and water absorption. The polyphenylene sulfide may be applied as a solid, or as a blown foam or a syntactic foam having a degree of foaming of up to about 50%.

The term “fusion bonded epoxy”, as used in this application to describe a coating layer, may be any fusion bonded epoxy as that term is used in the art.

The polypropylene may be in the form of a solid, a blown foam or a syntactic foam, for example, an expanded polypropylene foam. The polypropylene may be a polypropylene compound (i.e. a compound which contains polypropylene) which may be fully crosslinked, partially crosslinked, or non-crosslinked. It may be a homopolymer, a random copolymer, or a block copolymer.

The polystyrene may be any compound containing polystyrene and may be in the form of a solid, a blown foam or a syntactic foam. The polystyrene may comprise high impact polystyrene and may be non-crosslinked, partially crosslinked, or fully crosslinked.

Tie layers, in general, are well known in the art, and tables and charts exist for determining an appropriate tie layer as between any two polyolefin layers one wished to improve bonding therebetween. For example, the tie layer may comprise a ethylene-vinyl acetate, ethylene-methyl acrylate, a maleic anhydride grafted polypropylene, and a maleic anhydride grafted polyethylene.

Interlayer adhesion may be further improved by surface activation of one or more of the surfaces to be adhered. Alternatively, the use of the epoxy layer between two other layers of coating may decrease or eliminate the need for such surface activation. Surface activation can be accomplished by any method known in the art, such as a pretreatment which activates a surface by forming or attaching functional or polar chemical groups to the surface (for example, oxidation, utilizing an oxygen-rich flame or a corona discharge). Other surface treatments may include exposure to high-energy gas plasma utilizing a suitable gas, such as oxygen or nitrogen containing gases.

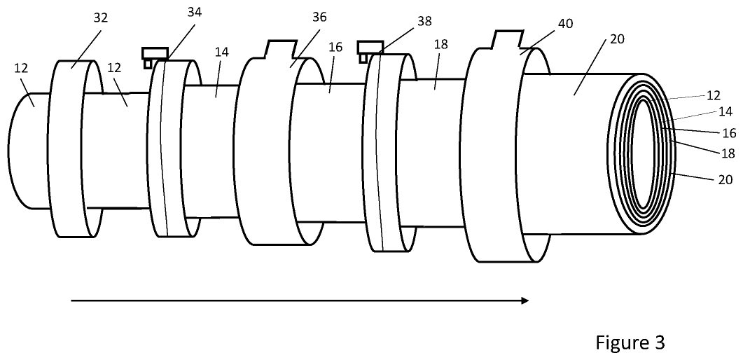

The multi layer pipe 10 of the present invention may be made utilizing any method typically utilized for the manufacture of multi layer pipe. FIG. 3 shows one such method, in schematic form.

A steel pipe 12 is displaced longitudinally along a platform (not shown) on rollers (not shown). The steel pipe 12 is cleaned, blasted, and acid treated (not shown) so that the bare steel is exposed. The steel pipe 12 is displaced through an infra-red heater 32 which heats the pipe to a temperature at which a fusion bonded epoxy will melt and bond, for example between 180 and 250 degrees C. The hot steel pipe 12 is then displaced through a fusion bonded epoxy spray unit 34, which applies a sprayed powder of fusion bonded epoxy to the pipe 12 to form a homogenous anti-corrosion coating 14. As shown, fusion bonded epoxy spray unit 34 comprises a spray head which sprays epoxy powder while rotating around the pipe 12. However, any method of application may be used. For example, the spray head may be fixed, with the pipe being simultaneously rotated while being conveyed forward along its longitudinal axis. The fusion bonded epoxy may be a high-temperature FBE. A sprayed liquid epoxy or other form of epoxy may be used instead of fusion bonded epoxy. The anti-corrosion coating 14 may also be an epoxy phenolic, a polyphenylene sulphide or a polyimide, including modified versions and blends thereof. The FBE may be a high temperature epoxy that is thermoset such that it does not soften at elevated temperature. It may comprise 100% solids. The FBE may comprise a commercial product such as Scotchkote 626-155™ by 3M, Nap-Gard 7-2555™ by DuPont, or PipeClad HOT 150™ by Sherwin Williams. It would be appreciated that other FBEs may also be suitable.

The pipe coated with anti-corrosion layer 14 is displaced through an extrusion die 36 for the application of coating layer 16. As would be appreciated, coating layer 16 may be applied by any manner known in the art; as shown, it is applied utilizing an annular cross head extrusion die 36 attached to a thermal insulation extruder (not shown) resulting in coverage of the entire surface of the pipe by virtue of the annular die forming the coating into a tubular profile around the conveyed pipe, thus applies an even coating of coating to form a homogeneous coating layer 16. Alternatively, a side-wrap technique may be used, whereby the coating is extruded through a flat strip or sheet die, in the form of a sheet or tape, which is then wrapped around the pipe, with one or more wraps necessary to achieve the desired thickness, and individual wrapped layers fused together by virtue of their molten state. As might be appreciated, if a side-wrap extrusion technique is utilized, the pipe may need to be simultaneously rotated and conveyed forward along its longitudinal axis. Coating layer 16, being the insulation layer closest to the pipe 12, may be designed to withstand operating temperatures currently used for the thermal insulation of subsea pipelines, such as the systems described in U.S. Pat. No. 8,397,765, or in WO 2014/131127, both incorporated herein by reference. Coating layer 16 may comprise polyphenylene sulfide, polystyrene or polypropylene. Preferably, coating layer 16 is polyphenylene sulfide or polypropylene.

Next, the pipe, coated with coating 16 is passed through an epoxy spray unit, such as fusion bonded epoxy spray unit 38, which applies a sprayed powder of fusion bonded epoxy to the coated pipe 16 to form an intermediate coating 18. As shown, fusion bonded epoxy spray unit 38 comprises a spray head which sprays epoxy powder while travelling around the coated pipe 16. However, any method of application may be used, as described above for anti-corrosion layer 14—for example, the pipe may be rotating and the spray head may be fixed. The fusion bonded epoxy may be a high-temperature FBE. The FBE may be a high temperature epoxy that is thermoset such that it does not soften at elevated temperature. It may comprise 100% solids. Other forms of epoxy, such as a sprayed liquid epoxy, a two-part epoxy, etc., may be used with appropriate modifications to the description of the spray head.

It would be appreciated that where the intermediate coating step is performed quickly and inline, coating 16 has not yet had time to set or completely cool. As such, the intermediate coating 18 is applied to a hot, soft, coating 16. It has been found that this improves the inter layer adhesion between the coatings. In other embodiments, however, intermediate coating 18 may be applied to a cooled coating 16, or a coating 16 which has had time to cool and set, but is then re-heated. Optionally, even in configurations where the intermediate coating step is performed quickly and inline, it may be desirable to apply additional heat to coating 16, for example, through the use of an inline infra-red heater, before the application of intermediate coating 18.

Next, the pipe, coated with intermediate coating 18 is passed through a second extrusion die 40 for the application of coating layer 20. As would be appreciated, coating layer 20 may be applied by any manner known in the art; as shown, it is applied utilizing a cross head extrusion die 40, which applies an even coating of coating to form a homogeneous coating layer 20. Coating layer 20, being an insulation layer further from the pipe 12, may be designed to withstand operating temperatures lower than that of coating layer 16. Coating layer 20, a polystyrene, polypropylene, or a polyphenylene sulfide, may be a solid, syntactic, or foam. It would be appreciated that coating layer 20 should not be the same thermoplastic as coating layer 16.

As with the application of intermediate coating 18, it would be appreciated that where the application of coating layer 20 is performed quickly and inline, coating 18 may not have time to set or completely cool. As such, coating layer 20 is applied to a hot, soft, intermediate coating 18 that has not completed gelled. It has been found that this improves the inter layer adhesion between the coatings. Optionally, even in configurations where the application of coating layer 20 is performed quickly and inline, it may be desirable to apply additional heat to coating 18, for example, through the use of an inline infra-red heater, before the application of coating layer 20.

Thus FIG. 3 shows, schematically, the manufacture of a pipe length as seen in cross-section in FIG. 1. It would be appreciated that a multi-layer pipe length as seen in cross-section in FIG. 2 could also be prepared utilizing the method as described herein, with additional intermediate extrusion, spray, or other application stations (and, if desired, heaters) for the application of any desired tie layers.

It would be appreciated that further apparatus and steps may be part of the method. For example, intermediate heating steps may be performed, for example, in line, by the addition of further heating units similar to heater 32. Additional coating steps may be performed, for example, in line, by the addition of further extruders or spray coating apparatus.

Accordingly, as would be appreciated, the method of FIG. 3 can be modified, with further coating administration steps and apparatus as necessary, to manufacture a pipe as shown in cross section in FIG. 2.

Although an in-line method has been shown and explained, it would be appreciated that any one or more of the steps could be performed separately. For example, a pipe length already coated in anti-corrosion coating and a first insulation layer could be utilized to make a pipe length of the present invention, by (a) heating the pipe to close to or higher than the melting point of the first insulation layer; (b) applying an FBE powder coat to form a uniform FBE layer overtop of the first insulation layer; (c) applying a second insulation layer.

It would also be appreciated that the insulation coating layers (for example, coatings 16, 20) or the intermediate layer 18, or the adhesive layers 14, 24, or 26, could be applied as a fusion bonded powder by spraying the pipe with powder-spray guns, passing the pipe through a “curtain” of falling powder or using a fluidized bed containing the powder, with melt fusion of the powder occurring as a result of the contact with the hot pipe. Or, as a liquid coating using liquid spray guns instead of the extrusion method as taught.

Extrusion can be accomplished using a single screw extrusion, or by twin screw extrusion methods. A two stage screw can also be used, containing a decompression zone at which point a gas or liquid physical foaming agent can be introduced into the polymer melt. The first stage acts to melt and homogenize the polymer, whereas the second stage acts to disperse the foaming agent, cool the melt temperature, and increase the melt pressure prior to the melt exiting the die. This may also be accomplished by tandem extrusion, or any other extrusion method known and typical in the art, for example, as described in WO 2014/131127, incorporated herein by reference.

### EXAMPLE 1

### Ring Shear Testing of Multilayer Pipe Coating

A pipe coated according to the present invention was manufactured, as herebefore described, and tested for shear. The metal pipe was coated as follows, in order, starting with the layer closest to the pipe: a Fusion Bonded Epoxy layer (approximately 400 micrometers thick), a polypropylene adhesive layer (approximately 250 micrometers thick), a polypropylene layer (approximately 10 mm), a polypropylene adhesive layer (approx. 100 micrometers thick), a fusion bonded epoxy layer (approximately 100 micrometers thick), a polystyrene adhesive layer (approximately 100 micrometers thick), followed by a layer of polystyrene (approximately 10 mm thick).

Ring shear was tested at 23 ° C. as well as at 95 ° C. using the ISO 12736 standard methodology (incorporated herein by reference) with a test speed of 1 mm/min and slack (toe) correction. Maximum shear stress was excellent at both temperatures, and at 23 ° C., shear load exceeded the maximum load limit of the testing equipment.

Although the invention has been described in connection with certain embodiments, it is not limited thereto. Rather, the invention includes all embodiments which may fall within the scope of the following claims.

1-37 (cancelled).

38. A multi layer coated steel pipe, comprising:
a. an inner steel pipe;
b. a first layer of coating, which is an anti-corrosion coating;
c. a second layer of coating, comprising a thermoplastic selected from the group consisting of polyphenylene sulfide, polypropylene, and polystyrene;
d. an epoxy intermediate layer between the second layer of coating and a third layer of coating; and
e. the third layer of coating, which comprises a thermoplastic selected from the group consisting of polyphenylene sulfide, polypropylene and polystyrene;
wherein the second layer of coating and the third layer of coating comprise different thermoplastics.

39. The multi layer coated steel pipe of claim 38, wherein the epoxy intermediate layer is a fusion bonded epoxy, such as a powder coated fusion bonded epoxy.

40. The multi layer coated steel pipe of claim 38, further comprising one or more additional layers of coating overtop of the third layer of coating.

41. The multi layer coated steel pipe of claim 38, wherein the first layer coating is an epoxy coating, preferably a fusion bonded epoxy.

42. The multi layer coated steel pipe of claim 38, further comprising one or more tie layers, each tie layer situated between any two layers of coating.

43. The multi layer coated steel pipe of claim 42 wherein the first layer of coating is a fusion bonded epoxy, the second layer of coating comprises polyphenylene sulfide, the third tie layer is a maleic anhydride grafted polypropylene, and the third layer of coating is a polypropylene.

44. The multi layer coated steel pipe of claim 42 wherein the first layer of coating is a fusion bonded epoxy, the second layer of coating is a polypropylene, the second tie layer is a maleic anhydride grafted polypropylene, the third tie layer is a maleic anhydride grafted polystyrene, and the third layer of coating is a polystyrene.

45. A method of manufacturing a multi layered coated steel pipe section, comprising:
a. displacing a steel pipe section longitudinally through a coating apparatus;
b. applying a first layer of circumferential coating onto said steel pipe section;
c. applying a second layer of circumferential coating, comprising a thermoplastic selected from the group consisting of polyphenylene sulfide, polypropylene, and polystyrene, onto said first layer of circumferential coating by said coating apparatus;
d. applying an epoxy layer onto said second layer of circumferential coating;
e. applying a third layer of circumferential coating, comprising a thermoplastic selected from the group consisting of polyphenylene sulfide, polypropylene and polystyrene, onto said fusion bonded epoxy layer;
wherein the first layer and the third layer comprise different thermoplastics.

46. The method of claim 45 wherein the epoxy layer is a fusion bonded epoxy layer, such as a powder coated fusion bonded epoxy layer.

47. The method of claim 46 wherein, prior to the application of the fusion bonded epoxy layer, the second layer of circumferential coating is heated to above or near its melting point.

48. The method of claim 45 wherein the application of the first layer of circumferential coating onto said steel pipe section is by said coating apparatus.

49. The method of claim 45 wherein the first layer coating is an epoxy coating, preferably a fusion bonded epoxy and the application of said first layer is by means of a powder coating.

50. The method of claim 45 further comprising:
a step b1 between steps (b) and (c), wherein step b1 comprises applying a first tie layer overtop of said first layer of circumferential coating, before applying the second layer of circumferential coating; and/or
a step (c1) between steps (c) and (d), wherein step c1 comprises applying a second tie layer overtop of said second layer of circumferential coating, before applying the epoxy layer; and/or
a step (d1) between steps (d) and (e), wherein step d1 comprises applying a third tie layer overtop of said epoxy layer, before applying the third layer of circumferential coating.

51. The method of claim 50, wherein the first layer of coating comprises a fusion bonded epoxy, the second layer of coating comprises a polyphenylene sulfide, the third tie layer comprises a maleic anhydride grafted polypropylene, and the third layer of coating comprises polypropylene.

52. The method of claim 50 wherein the first layer of coating comprises a fusion bonded epoxy, the second layer of coating comprises a polypropylene, the first tie layer comprises a maleic anhydride grafted polypropylene, the second tie layer comprises a maleic anhydride grafted polypropylene, the third tie layer comprises a maleic anhydride grafted polystyrene, and the third layer of coating comprises a polystyrene.

53. The method of claim 45, wherein:
step c occurs before the first layer of circumferential coating is fully gelled; and/or
step d occurs while the second layer of circumferential coating is still above its softening point; and/or
step e occurs before the epoxy layer is fully gelled.

54. The method of claim 8, wherein:
the application of the epoxy layer is performed by the coating apparatus; and/or the application of the third layer of circumferential coating is performed by the coating apparatus; and/or
the application of one or more of the first, second, and third tie layers is performed by the coating apparatus.

55. The method of claim 45 wherein all steps are performed in-line.

56. The method of claim 45, further comprising applying a fourth layer of circumferential coating overtop of the third layer and/or
applying a outer jacket coating overtop of the third or fourth layer of circumferential coating.

57. The method of claim 56, wherein the fourth layer of circumferential coating is a polypropylene or a polystyrene.
